(19) United States
(12) Patent Application Publication
(10) Pub. No.: US 2011/0239147 A1
(43) Pub. Date: Sep. 29, 2011

(54) DIGITAL APPARATUS AND METHOD FOR PROVIDING A USER INTERFACE TO PRODUCE CONTENTS

(76) Inventors: Hyun Ju Shim, Seoul (KR); Yong Bang Ho, Sungmam-si (KR); Bo Gyeong Kang, Seoul (KR); Kyung Soo Kwag, Suwon-si (KR); Dong Hoon Kim, Snchang-gun (KR); Wook Hee Min, Seoul (KR)

(21) Appl. No.: 12/909,373

(22) Filed: Oct. 21, 2010

(30) Foreign Application Priority Data
Mar. 25, 2010 (KR) 10-2010-0026521

(51) Int. Cl. G06F 3/048

(52) U.S. Cl. 715/769; 715/849

(57) ABSTRACT

A digital apparatus that provides a graphical user interface (GUI) for producing contents is provided. The digital apparatus may provide multiple screens, for example, a first GUI screen, a second GUI screen, and a third GUI screen. The first GUI screen may be used for setting at least one background item as contents. The second GUI screen may be used for setting at least one 3D avatar item as contents. The third GUI screen may be used for setting at least one scenario item as contents. The digital apparatus may produce the contents by combining the items set as contents on the first through the third GUI screens, respectively, based on a user set signal.

### CROSS-REFERENCE TO RELATED APPLICATION(S)

This application claims the benefit under 35 U.S.C. §119(a) of Korean Patent Application No. 10-2010-0026521, filed on Mar. 25, 2010, in the Korean Intellectual Property Office, the entire disclosure of which is incorporated herein by reference for all purposes.

### BACKGROUND

1. Field

The following description relates to a digital apparatus and a method for providing a graphical user interface (GUI), and a recording media storing a program to implement the method.

2. Description of Related Art

As digital apparatuses have increased, the amount of contents used and the variety of contents produced have also increased. The various types of contents include, for example, an image including a character or a background image, video, audio, a scenario, and the like, all of which may be grouped to be a single content.

Conventionally, a writer writes a scenario, a modeler designs a three-dimensional (3D) character, the background, the props, and the like, an animator sets a motion of the 3D character based on the scenario, and a sound engineer replays a background music and a sound effect, in order to produce 3D contents. The described method is typically performed by experts who are experienced with producing contents. The quality of such contents is usually excellent, however, such production requires a high cost and a great amount of time in order to produce the contents. Also, users that are not experienced or trained in the generation of such high quality contents are not capable of producing such contents.

A program that allows users of various digital apparatus to produce 3D contents has been developed. However, the 3D contents producing program has trouble grouping various contents, such as an image including a character or a background image, an audio, a scenario, and the like, and thus, a quality of 3D contents may be poor. Accordingly, there is a desire for a method that allows users of the digital apparatus to produce quality 3D contents in a relatively short amount of time.

### SUMMARY

In one general aspect, there is provided a digital apparatus, comprising an input unit to receive an inputted user set signal, a graphical user interface (GUI) providing unit to provide a first GUI screen for setting at least one background item as contents, a second GUI screen for setting at least one three-dimensional (3D) avatar item as contents, and a third GUI screen for setting at least one scenario item as contents, and a controller to control the GUI providing unit to combine the items set as contents on the first through the third GUI screens, respectively, based on the user set signal, to produce combined contents.

The GUI providing unit may provide the items set as contents on the first through the third GUI screens in real time as the items are set on the first through the third GUI screens, respectively.

The at least one background item may include at least one of a stage background, a background time-zone, a background weather, a background atmosphere, and a background music.

The second GUI screen may include a sub-GUI screen for setting at least one avatar characteristic from among an accessory, clothes, a name, a facial expression, a profile, and a voice which correspond to the at least one 3D avatar item.

The third GUI screen may include an item display area where scenario items are displayed, the scenario items may include at least one of a discriminating motion, a location motion, a whole body motion, a facial motion, and a conversation motion, each of which are distinguished based on body parts of the at least one 3D avatar item, and the third GUI screen may include a frame display area where a plurality of frames corresponding to the at least one 3D avatar item set on the second GUI screen are displayed.

The third GUI screen may further include a sub-menu to set a target location, with respect to the location motion, the target location corresponding to the at least one 3D avatar item and a target direction at the target location.

The frame display area may display the at least one set 3D avatar item on a first axis and may arrange the plurality of frames respectively corresponding to the at least one 3D avatar item in chronological order on a second axis that is orthogonal to the first axis.

When one of the scenario items is dragged from the item display area of the third GUI screen and is placed on one of the frames displayed on the frame display area, the GUI providing unit may set the dragged scenario item on the frame where the dragged scenario is placed.

When the placed scenario item is of the same type of as a scenario item that is already set on the frame where the dragged scenario is placed, the GUI providing unit may cancel the setting of the dragged scenario item.

When the at least one scenario item is set on each of the plurality of frames, the GUI providing unit may synchronize the at least one scenario item set on the same frame based on one of a shortest motion reference mode, a longest motion reference mode, and a random motion reference mode.

The apparatus may further comprise a communication unit to communicate with other digital apparatuses, wherein the controller controls the communication unit to transmit the combined contents produced by the GUI providing unit to a predetermined another digital apparatus.

In another aspect, there is provided a method of providing a GUI for producing contents, the method comprising providing a first GUI screen for setting at least one background item as contents, providing a second GUI screen for setting at least one 3D avatar item as contents, providing a third GUI screen for setting at least one scenario item as contents, and producing combined contents by combining the items set as contents on the first through the third GUI screens, respectively, based on a user set signal.

The producing may comprise providing the items set as contents on the first through the third GUI screens in real time as the items are set on the first through the third GUI screens, respectively.

The second GUI screen may include a sub-GUI screen for setting at least one avatar characteristic from among an accessory, clothes, a name, a facial expression, a profile, and a voice which correspond to the at least one 3D avatar item.

The third GUI screen may include an item display area where scenario items are displayed, the scenario items may include at least one of a discriminating motion, a location motion, a whole body motion, a facial motion, and a conversation motion, each of which are distinguished based on body parts of the at least one 3D avatar item, and the third GUI screen may include a frame display area where a plurality of frames corresponding to the at least one 3D avatar item set on the second GUI screen are displayed.

The frame display area may display the at least one set 3D avatar item on a first axis and may arrange the plurality of frames respectively corresponding to the at least one 3D avatar item in chronological order on a second axis that is orthogonal to the first axis.

The producing may comprise setting a dragged scenario item on a frame where the dragged scenario is placed, when one of the scenario items is dragged from the item display area of the third GUI screen and is placed on one of the frames displayed on the frame display area.

The producing may comprise cancelling the setting of the dragged scenario item when the placed scenario item is of the same type as a scenario item that is already set on the frame.

The producing may comprise synchronizing the at least one scenario item set on the same frame based on one of a shortest motion reference mode, a longest motion reference mode, and a random motion reference mode, when the at least one scenario item is set on each of the plurality of frames.

In another aspect, there is provided a computer-readable storage medium having stored therein program instructions to cause a processor to implement a method of providing a GUI for producing contents, the method comprising providing a first GUI screen for setting at least one background item as contents, providing a second GUI screen for setting at least one 3D avatar item as contents, providing a third GUI screen for setting at least one scenario item as contents, and producing combined contents by combining the items set as contents on the first through the third GUI screens, respectively, based on a user set signal.

Other features and aspects may be apparent from the following description, the drawings, and the claims.

### BRIEF DESCRIPTION OF THE DRAWINGS

FIG. 1 is a diagram illustrating an example of a digital apparatus.

FIGS. 2 through 7 are diagrams illustrating examples of user interfaces for producing contents.

FIG. 8 is a flowchart illustrating an example of a method for producing contents.

FIG. 9 is a flowchart illustrating another example of a method for producing contents.

FIG. 10 is a flowchart illustrating another example of a method for producing contents.

Throughout the drawings and the description, unless otherwise described, the same drawing reference numerals should be understood to refer to the same elements, features, and structures. The relative size and depiction of these elements may be exaggerated for clarity, illustration, and convenience.

### DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

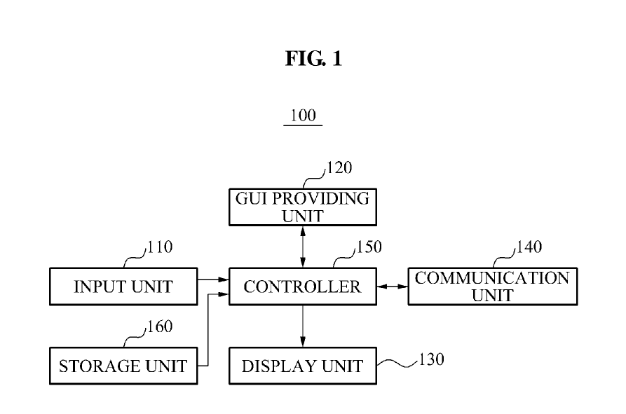

FIG. 1 illustrates an example of a digital apparatus. Referring to FIG. 1, the digital apparatus 100 includes an input unit 110, a graphical user interface (GUI) providing unit 120, a display unit 130, a communication unit 140, a controller 150, and a storage unit 160.

For example, the digital apparatus 100 may be a terminal, such as a cellular phone, a game console, a digital TV, a computer, and the like.

The input unit 110 may receive a signal that is input by a user. For example, the input unit 110 may be an input key including a mouse, which is included outside the digital apparatus 100, a touch screen, and the like.

The GUI providing unit 120 may provide a GUI for producing contents. For example, when the GUI providing unit 120 provides the GUI, the providing the GUI may include generating the GUI and displaying the GUI. In some embodiments, the operation of providing the GUI may only include generating the GUI.

For example, the GUI providing unit 120 may provide a first GUI screen, a second GUI screen, and a third GUI screen. The example including three screens is merely for purposes of example, and it should be understood that one or more screens may be used, for example, one screen, two screens, three screens, four screens, or more. The first GUI screen may be used for setting at least one background item for providing contents, the second GUI screen may be used for setting at least one 3D avatar item for producing the contents, and the third GUI screen may be used for setting at least one scenario item for producing the contents.

The background items in the first GUI screen may include, for example, a stage background, a background time-zone, a background weather, a background atmosphere, a background music, and the like. The 3D avatar items in the second GUI screen may include, for example, different avatar items. The second GUI screen may include a sub-GUI screen that may be used for setting at least one avatar characteristic, for example, an accessory, clothes, a name, a facial expression, a profile, a voice which correspond to the at least one 3D avatar item, and the like.

The third GUI screen may include an item display area where scenario items are displayed. The scenario items may include, for example, a discriminating motion, a location motion, a whole body motion, a facial motion, a conversation motion, and the like, which correspond to the at least one 3D avatar item set on the second GUI screen. The scenario items may include a frame display area in which a plurality of frames corresponding to the at least one 3D avatar item are displayed. In this example, the third GUI screen may further include a sub-menu to set a target location corresponding to the at least one 3D avatar item and a target direction at the target location, based on the location motion. For example, the target location may denote a destination of the 3D avatar item when the 3D avatar item moves by walking or running. The target direction may denote a direction in which the 3D avatar is heading or a destination in which the 3D avatar has arrived.

For example, the frame display area may display the at least one 3D avatar item set on the second GUI screen on a first axis on the third GUI screen, and may arrange the plurality of frames corresponding to the at least one 3D avatar item on a second axis that is orthogonal to the first axis. The plurality of frames may be arranged in chronological order. For example, the plurality of frames corresponding to the at least one 3D avatar item may be arranged on a horizontal axis to generate successive motions of the at least one 3D avatar item.

For example, when one of the scenario items is dragged from the item display area based on the user input signal inputted through the input unit 110 and is placed on one of the frames displayed on the frame display area, the GUI providing unit 120 may set the dragged scenario item on the frame where the dragged scenario is placed. In this example, when a scenario item set in advance does not exist in the corresponding frame, or when a different type of scenario item is set in advance, the GUI providing unit 120 may set the dragged and placed scenario item on the corresponding frame. When a scenario item to be set has a type that is the same as a scenario item that is already set on the frame where the dragged scenario is placed, the GUI providing unit 120 may cancel the setting of the dragged scenario item. For example, when a placed scenario item on a frame is a ‘location motion’ item and the corresponding frame already includes another ‘location motion’ item, setting of the placed ‘location motion’ item may be cancelled.

When at least one scenario item is set on each of the plurality of frames on the third GUI screen, the GUI providing unit 120 may synchronize at least one scenario set in the same frame to simultaneously replay the at least one scenario item. In addition, the GUI providing unit 120 may synchronize the at least one scenario item set in the same frame based on, for example, a shortest motion reference mode, a longest motion reference mode, and a random motion reference mode. Scenario items arranged in a top and a bottom of the first axis such as the vertical axis, and arranged in frames having the same frame number may be synchronized to be simultaneously replayed, even when the scenario items correspond to different avatar items. Scenario items that have the same frame number and that correspond to different avatar items may be simultaneously replayed by corresponding avatar items, and thus, an effect in which two or more avatar items are simultaneously replayed may be provided.

When items are set on the first through the third GUI screens, respectively, the GUI providing unit 120 may provide the set items on the first through the third GUI screens in real time. For example, when at least one of the stage background, the background time-zone, the background weather, the background atmosphere, and the background music are set on the first GUI screen, the GUI providing unit 120 may apply the corresponding background item on the first GUI screen.

The storage unit 160 may store various items for producing contents. The various items may be stored in a hierarchical structure. For example, background items, 3D avatar items, and scenario items used for producing the contents may be stored as upper menus, and a plurality of sub-menus corresponding to respective upper menus may be stored in connection with their upper menus. For example, the stage background, the background time-zone, the background weather, the background atmosphere, the background music, and the like, may be the upper menus with respect to the background item, and sub-menus associated with each of the upper menus may be stored. Examples of the sub-menus of the ‘stage background’ may include a classroom, an office, a theater, a studio, and the like, and the sub-menus may be stored in connection with the ‘stage background’.

The communication unit 140 may communicate with one or more digital apparatuses via a wireless network, for example, an infrared ray communication scheme, a Bluetooth scheme, a third generation (3G) scheme, a Wireless Fidelity (WiFi) scheme, and the like.

When items are set on the first through the third GUI screens provided by the GUI providing unit 120, the controller 150 may control the GUI providing unit 120 to combine the set items to produce combined contents. For example, the controller 150 may control the GUI providing unit 120 to combine at least one background item set on the first GUI screen, at least one 3D avatar item set on the second GUI screen, and at least one scenario item set on each of the plurality of frames on the third GUI screen to produce the contents.

The contents are generated or produced based on the described operations, and the controller 150 may store the produced contents in a storage media (not illustrated) and may replay the contents through the display unit 130.

When another apparatus is determined in advance for contents transmission, the controller 150 may control the communication unit 140 to transmit the contents to the other apparatus. Accordingly, the contents produced by the digital apparatus 100 may be shared with a user of the other digital apparatus.

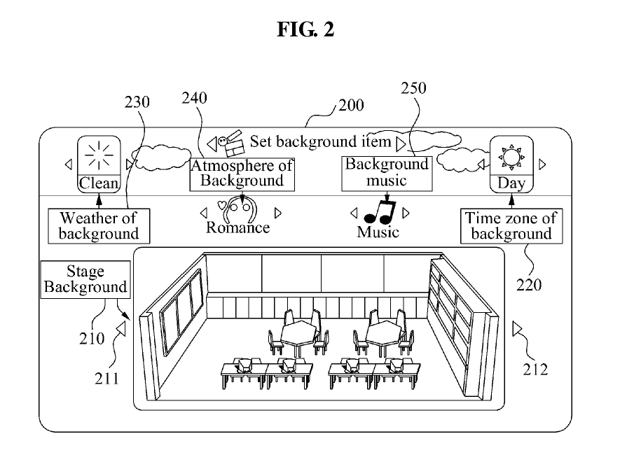

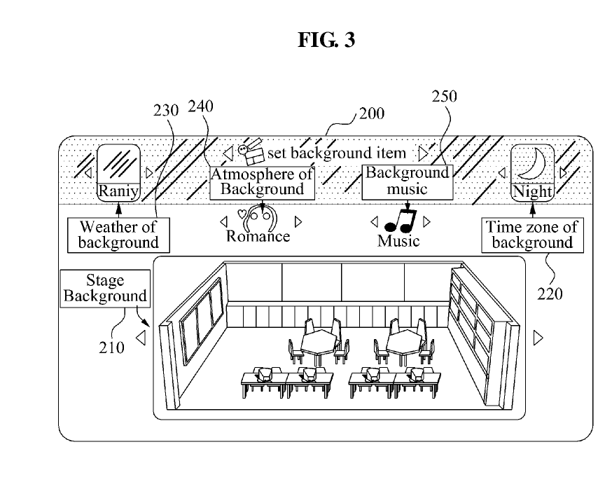

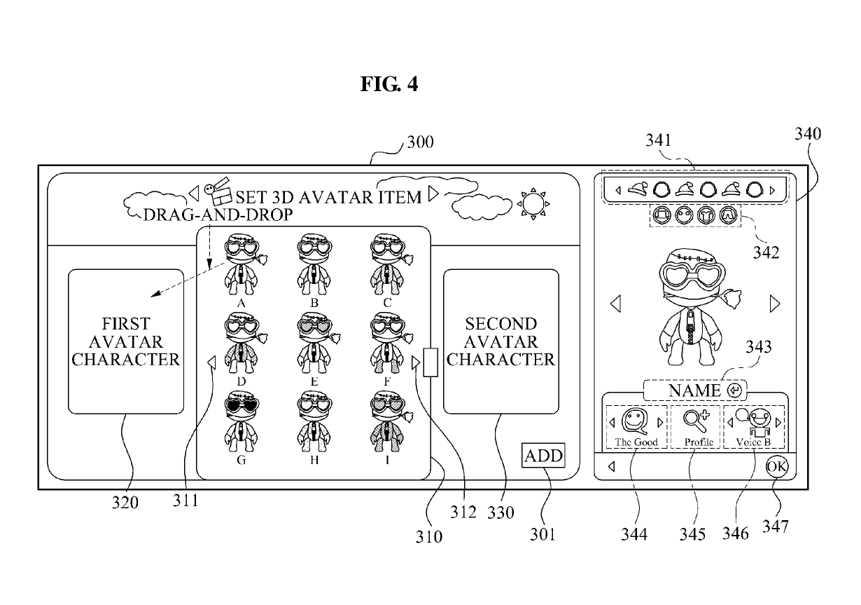

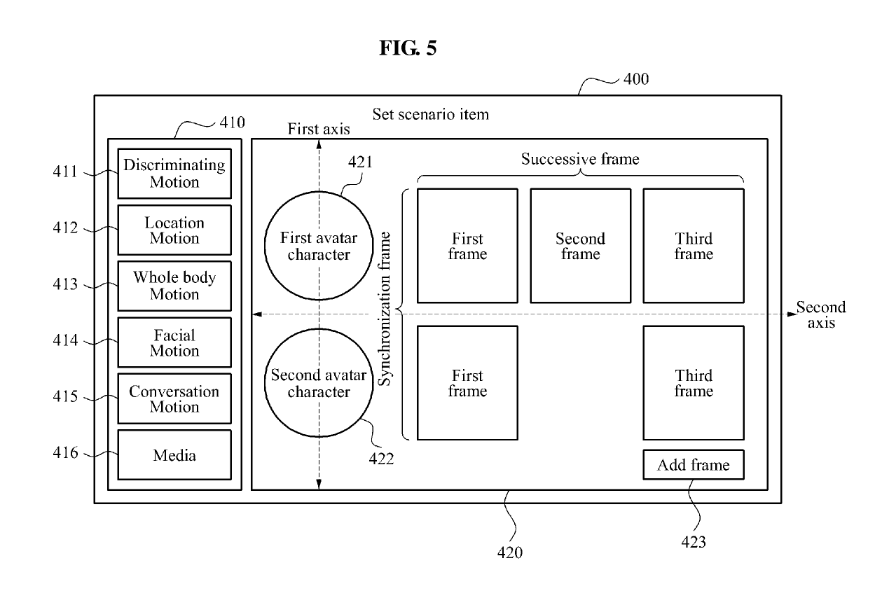

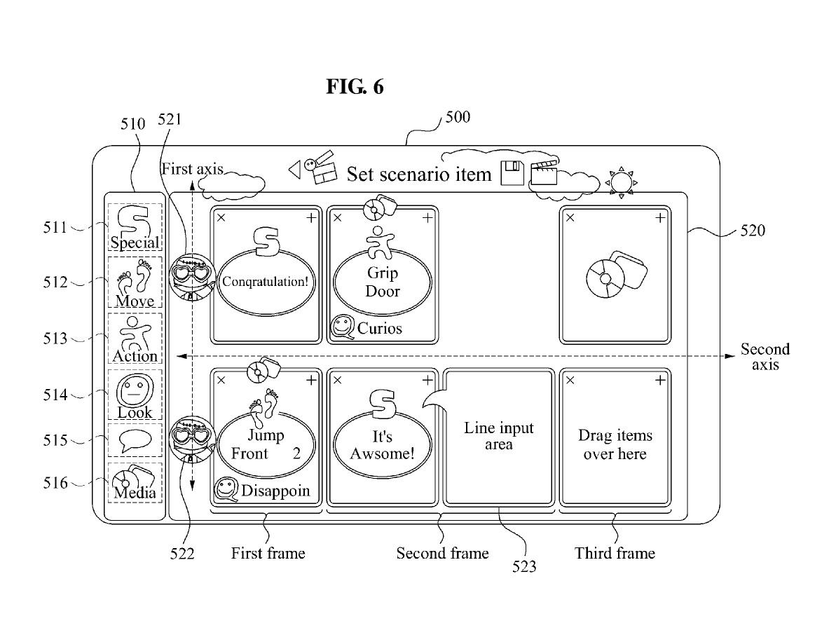

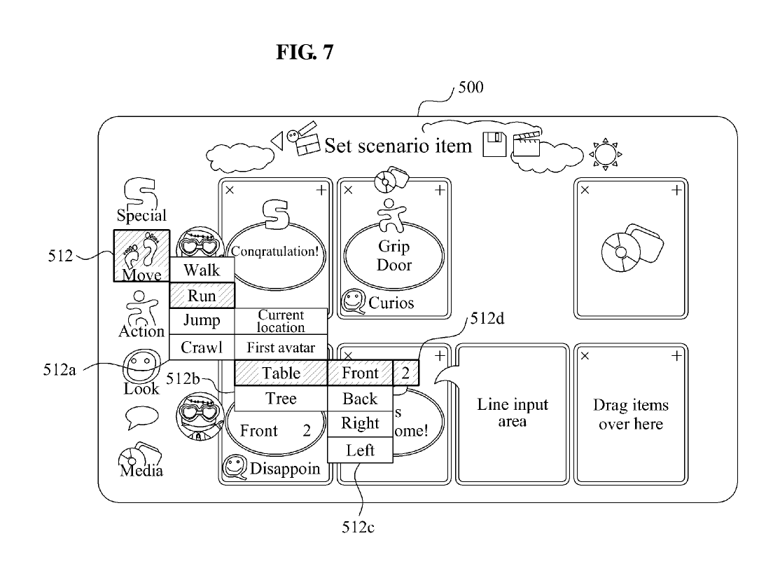

FIGS. 2 through 7 illustrate examples of GUIs for producing contents. FIGS. 2 and 3 illustrate examples of a first GUI screen 200 that may be used for setting at least one background item for producing contents. FIG. 4 illustrates an example a second GUI screen 300 that may be used for setting at least one 3D avatar item for producing contents. FIG. 5 illustrates an example of a third GUI screen 400 that may be used for setting at least one scenario item for producing contents. FIGS. 6 and 7 illustrate an example of a third GUI screen 500.

Referring to FIG. 2, the first GUI screen 200 is provided to enable the user to set at least one background item for producing contents. In this example, background items, such as a stage background 210, a background time-zone 220, a background weather 230, a background atmosphere 240, a background music 250, and the like, may be displayed on the first GUI screen 200.

The stage background 210 may denote a stage that is applied to the contents, and may be a location, for example, a classroom, an office, a theater, a studio, and the like. However, it should be appreciated that the stage background 210 is not limited thereto, and may be various places. The background time-zone 220 may denote a time of the displayed contents. For example, the background time-zone 220 may be used to determine whether content to be applied to the contents is day or night. The background weather 230 may denote a weather to be applied to the contents. The background atmosphere 240 may denote an atmosphere to be applied to the contents, and may be used for setting an atmosphere of the background. For example, the background atmosphere may be one of gloomy, happy, romance, and the like. The background music 250 may denote a music to be applied to the contents.

As an example, a user may change the stage background 210 on the first GUI screen 200 by pressing arrows 211 and 212 located in both sides of the stage background 210 with a touch screen or a mouse. When a place is displayed on the stage background 210 for a predetermined time, for example, for ten seconds, the first GUI screen 200 may determine the corresponding place as the stage background 210.

A user may set the background time-zone, the background weather 230, the background atmosphere 240, and the background music 250. For example, the user may set the stage background 210 to ‘class’, may set the background time-zone 220 to ‘day’, may set the background weather 230 to ‘clean’, may set the background atmosphere 240 to ‘romance’, and may set the background music 250 to ‘music 1’. For example, a user may set all the background items included in the first GUI screen 200, or may set one background item or several background items.

FIG. 3 illustrates the first GUI screen 200 in which different background items from FIG. 2 are set. Referring to FIG. 3, the user may press one of two arrows located in both sides of each item, when the user wants to change the background time-zone 220 and the background weather 230 on the first GUI screen 200 of FIG. 2. For example, the background time-zone 220 may be set to ‘night’, and the background weather 230 may be set to ‘rainy’.

When the user presses an arrow to change the background time-zone 220 into ‘night’, the first GUI screen 200 may darken a background in real time. When the background weather 230 is changed into ‘rainy’, the first GUI screen 200 may apply an effect of raining on the background in real time. The first GUI screen 200 of FIG. 2 may be changed and may be set as illustrated in FIG. 3. When at least one background item is set on the first GUI screen 200, the digital apparatus 100 may store information associated with each of the at least one set items.

When the at least one background item is set on the first GUI screen 200, the user may press an arrow on a top of the first GUI screen 200 to display a second GUI screen 300, as illustrated in FIG. 4. The second GUI screen 300 may be provided for setting at least one 3D avatar item in the contents. For example, the second GUI screen 300 may include a 3D avatar item display area 310, a first avatar character setting area 320, and a second avatar character setting area 330. The second GUI screen 300 may further include a sub-GUI screen 340 that may be used for setting at least one avatar characteristic from among an accessory, clothes, a name, a facial expression, a profile, a voice which correspond to the at least one 3D avatar item, and the like.

The 3D avatar item display area 310 may include different 3D avatar items. The first avatar character setting area 320 and the second avatar character setting area 330 may be areas that are used for setting avatar characters on the contents. The sub GUI screen 340 may be an area used for setting various features, for example, an accessory, clothes, a name, a facial expression, a profile, a voice, and the like, which correspond to the at least one 3D avatar item set in the first avatar character setting area 320 and the second avatar character setting area 330. For example, the sub GUI screen 340 may include an accessory setting area 341, a clothes setting area 342, a name input area 343, a facial setting area 344, a profile setting area 345, a voice setting area 346, and the like.

A user may drag a 3D avatar item from the 3D avatar item display area 310 and may place the dragged 3D avatar item on the first avatar character setting area to set a first avatar character 320. An avatar character may be the same as a 3D avatar item. When a desired 3D avatar item does not exist, the user may view other 3D avatar items by pressing arrows 311 and 312.

When a user wants additional avatar characters, the user may set a second avatar character in the same manner as the first avatar character. An avatar character is the same as a 3D avatar item.

When the first avatar is set, the second GUI screen 300 may display the first avatar character on the sub GUI screen 340. A user may set at least one avatar characteristic such as an accessory, clothes, a name, a facial expression, a profile, a voice, and the like, with respect to the first avatar character, on the sub GUI screen 340. In this example, when one of the at least one avatar characteristics is set or changed on the sub GUI screen 340, the second GUI screen 300 may apply and display the set or changed avatar characteristic to the first avatar character in real time.

When the user presses an ‘OK’ item 347 located in a bottom of a left side of the sub GUI screen 340 after the setting is completed, the second GUI screen 300 may display the first avatar character to which the at least one avatar characteristic is set on the first avatar character setting area 320. Similarly, at least one avatar characteristic with respect to the second avatar characteristic may be set.

When the setting of the at least one 3D avatar item is completed on the second GUI screen 300, the user may press an arrow on a top of the second GUI screen 300 to display a third GUI screen 400 as illustrated in FIG. 6. An example of the third GUI screen 400 of FIG. 6 is described with reference to FIG. 5.

Referring to FIG. 5, the third GUI screen 400 may be provided for setting at least one scenario item for producing contents. For example, the third GUI screen 400 may be used to set at least one scenario item including a motion of an avatar character, lines, a sequence of the lines, and the like. The third GUI screen 400 may include a scenario item display area 410 and a frame display area 420.

For example, the scenario item display area 410 may display a discriminating motion 411, a location motion 412, a whole body motion 413, a facial motion 414, and a conversation motion 415 which are distinguished based on parts of a body of at least one 3D avatar item. The discriminating motion 411, the location motion 412, the whole body motion 413, the facial motion 414, and the conversation motion 415 may be included in upper menus with respect to a scenario item, and each of the upper menus may include a plurality of sub-menus.

The frame display area 420 may arrange a plurality of frames corresponding to at least one avatar character that is set on the second GUI screen 300. For example, the third GUI screen 400 may display a first avatar character 421 and a second avatar character 422 on a first axis such as a vertical axis in the frame display area 420. The third GUI screen 400 may arrange the plurality of frames respectively corresponding to the first avatar character 421 and the second avatar character 422 in chronological order on a second axis that is orthogonal to the first axis. The first avatar character 421 and a plurality of frames corresponding to the first avatar character 421 may be arranged on the same horizontal axis.

For example, the first through third frames corresponding to the first avatar character 421 may be successive frames in the frame display area 420. The first through third frames corresponding to the second avatar character 422 may also be successive frames. In FIG. 5, the second frame of the second avatar character 422 is not defined, unlike the first avatar character 421. In this example, the second avatar character 422 may continuously perform at least one scenario item that is set on the corresponding first frame or may perform a rest motion such as entering into an idle state, while the first avatar character 421 performs at least one scenario item that is set on the second frame. When the first avatar character 421 completes performing at least one scenario item that is set on the second frame, the first avatar character 421 and the second avatar character 422 may simultaneously perform corresponding scenario items respectively that are set on their third frames.

Frames that have the same frame number from among frames corresponding to the first avatar character 421 and the second avatar character 422 may be synchronization frames in the frame display area 420. The frames that have the same frame number may be simultaneously replayed during the same period of time, while contents are replayed.

The frame display area 420 may include a ‘frame addition’ item 423 for adding a frame. Accordingly, the user may add a frame when the frame is desired.

The user may set at least one scenario item for producing contents through the third GUI screen 400 of FIG. 5. Setting of the at least one scenario item is described with reference to FIGS. 6 and 7.

A third GUI screen 500 of FIG. 6 is an example of a display on a screen, and the third GUI screen 500 has a similar configuration as that of the third GUI screen 400 of FIG. 5. The third GUI screen 500 may include a scenario item display area 510 and a frame display area 520. For example, a first avatar character 521 and a second avatar character 522 set on the second GUI screen 300 may be displayed on a first axis of the frame display area 520

In the example of FIGS. 6 and 7, ‘special’ denotes a discriminating motion 511, ‘move’ denotes a location motion 512, ‘action’ denotes a whole body motion 513, ‘look’ denotes a facial motion 514, a speech balloon denotes a conversation motion 515, and ‘media’ denotes a media 516. When the user selects the discriminating motion 511 from the item display area 510, the third GUI screen 500 may display a plurality of sub-menus that correspond to the discriminating operation 511. The user may select a sub-menu from the plurality of sub-menus corresponding to the distinguishing motion 511 to select a scenario item with respect to the distinguishing motion 511. When the user drags the selected scenario item and places the selected scenario item on a second frame that corresponds to the second avatar character 522, the third GUI screen 500 may sense the drag-and-place, and may set the dragged scenario item on the second frame. In the same manner, a user may set least one scenario item on another frame.

When the user intends to set a scenario item associated with the conversation motion 515 on the second frame, the user may drag the conversation motion 515 and place the conversation motion 515 on the second frame corresponding to the second avatar character 522 on the third GUI screen 500. Accordingly, the third GUI screen 500 may display a line input area 523 in one side of the second frame.

The third GUI screen 500 may not set all the scenario items set by the user on the corresponding frame. The third GUI may determine whether a scenario item has a type that is the same as the type as the dragged scenario item that is already set on the corresponding frame where the dragged scenario is placed, when the user drags the scenario item and places the dragged scenario item on the corresponding frame. When the scenario item, has a type that is the same as the dragged scenario item already set on the corresponding frame, the third GUI screen 500 may cancel the setting of the dragged item.

Conversely, when the same type scenario item is not set on the corresponding frame, the third GUI screen 500 may set the dragged scenario on the corresponding frame. For example, when a scenario item associated with the conversation motion 515 is already set on the second frame corresponding to the second avatar character 522, and the user tries again to set another scenario item associated with the conversation motion 515, the third GUI screen 500 may cancel the other scenario item associated with the conversation motion 515. The second avatar character 522 may not simultaneously perform different conversation motions on the second frames. Accordingly, the setting of the same types of scenario items may be prevented.

When a scenario item associated with the conversation motion 515 is already set on the second frame corresponding to the second avatar character 522, and the user again tries to set another scenario item associated with one of the discriminating motion 511, the location motion 512, the while body motion 513, the facial motion 514, and the media 516, as opposed to setting another scenario item associated with the conversation motion 515, the third GUI screen 500 may set the corresponding scenario item on the second frame. In this example, the second avatar character 522 may simultaneously perform the newly set scenario item and the previously set scenario item associated with the conversation motion 515. Accordingly, the second avatar character 522 may simultaneously perform a conversation and the newly set scenario item.

When a scenario item is not set on the second frame that corresponds to the second avatar character 522, and the user tries to set a scenario item associated with the conversation item 515, the third GUI screen 500 may display the line input area 523 in one side of the second frame to set the conversation motion 515. Therefore, the user may input a text on the line input area 523 to set the conversation motion 515.

When a scenario item is set on one of the frames, the third GUI screen 500 may configure the corresponding frame, previous frames, and subsequent frames to be successive. Therefore, the arranged frames corresponding to the first avatar character 521 of the second avatar character 522 may be continuously replayed without discontinuity, after the production of the contents is completed.

When at least two scenario items are set on one of the frames, the third GUI screen 500 may synchronize the scenario items to enable the scenario items to be simultaneously replayed. The third GUI screen 500 may synchronize scenario items set in frames that have the same frame number from among frames corresponding to the first avatar character 521 and the second avatar character 522 such that the scenario items have the same execution time.

In this example, the third GUI screen 500 may synchronize the scenario items set on the same frame based on one of a shortest motion reference mode, a longest motion reference mode, and a random motion reference mode. The shortest motion reference mode may adjust the execution times of remaining scenario items based on a scenario item that has a shortest execution time. The longest motion reference mode may adjust execution times of remaining scenario items based on a scenario item that has the longest execution time. The random motion reference mode may adjust the execution times of remaining scenario items based on the execution time of a random scenario item.

When the user selects a scenario item associated with the location motion 512 on the third GUI screen 500 of FIG. 6, the third GUI screen 500 may display a sub-menu for setting a target location that corresponds to an avatar character and a target direction at the target location. For example, when the user sets the location motion 512 on a frame corresponding to the avatar character, the user may set the target location that indicates where to move and may set the target direction where the avatar character is heading toward the target location when the avatar character arrives at the target location, unlike an example in which the user selects scenario items that have types that are different from the location motion 512.

Referring to FIG. 7, when the user selects the location motion 512, the third GUI screen 500 may display a scenario item display table 512a associated with the location motion 512. In this example, the scenario item display table 512a includes motions, for example, ‘walk’, ‘run’, ‘jump’, ‘crawl’, and the like.

When the user selects ‘run’ on the scenario item display table 512a, the third GUI screen 500 may display a target location table 512b in one side of the scenario item display table 512a. In this example, the target location table 512b may include the target location, such as a current location, a first avatar, a table, a tree, and the like. The various target locations included in the target location table 512b may be changed dynamically based on the stage background 210 set on the first GUI screen 200 shown in FIGS. 2 and 3. The target location table 512b may be reconfigured based on objects, locations, and the like, included in the stage background 210 set on the first GUI screen 200.

When the user selects ‘table’ on the target location table 512b, the third GUI screen 500 may display a target direction table 512c on one side of the target location table 512b. In this example, the target direction table 512c may include the target direction, such as, ‘front’, ‘back’, ‘right’, ‘left’, and the like. The target direction may not be limited to ‘front’, back, ‘right’, and ‘left’ and may further include, for example, ‘up’, ‘down’, and the like. The target direction may also include target directions based on angles.

When the user selects the ‘front’ on the target direction table 512c, the third GUI screen 500 may display a distance table 512d on one side of the target direction table 512c. In this example, the distance table 512d is provided for setting a distance that the avatar character is to move away from the target location, and may be set by the user through inputting a number, for example, ‘2’. In this example, a unit of the distance may be a ‘step’ or a ‘centimeter’.

Referring to FIG. 7, a location motion may be set on the frames such that the avatar character runs and locates at ‘2’ steps away from the table based on the ‘table’ that is the target location. Therefore, the avatar character may perform the location motion, and a motion of the avatar character is more actively and realistically performed when the contents are replayed.

The digital apparatus 100 may combine at least one background item, at least one 3D avatar item, and at least one scenario item set on the first through the third GUI screens 200, 300, 400, and 500 of FIGS. 3, 4, 6, and 7 to produce contents. The digital apparatus 100 may replay the contents, and may transmit the contents to another digital apparatus.

Although FIGS. 2 through 7 describe that the first through the third GUI screens 200, 300, 400, and 500 control displayed motions, and the user may control the displayed motions on the first through the third GUI screens 200, 300, 400, and 500 via a selection by the user, or a setting by the user.

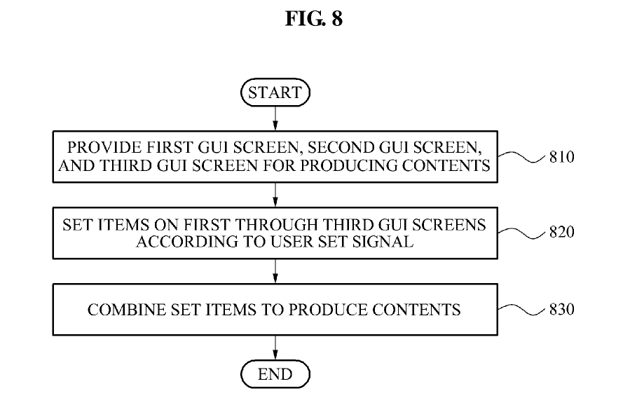

FIG. 8 illustrates an example of a method for producing or generating contents. Referring to FIG. 8, the digital apparatus 100 provides a first GUI screen, a second GUI screen, and a third GUI screen for producing contents, in 810. For example, the digital apparatus 100 may provide the first GUI screen used for setting at least one background item for producing the contents, may provide the second GUI screen used for setting at least one 3D avatar item, and may provide at least one scenario item. In this example, the digital apparatus 100 may not display the first through the third GUI screens on a single screen, but may instead sequentially provide the first through the third GUI screens.

Subsequently, the digital apparatus 100 sets items on the first through the third GUI screens, respectively, based on a user set signal, in 820. For example, when the user selects the at least one background item, the at least one 3D avatar item, and the at least one scenario item on the first through the third GUI screens, respectively, the digital apparatus 100 may receive corresponding user set signals to set the selected items.

The digital apparatus 100 combines the items set on the first through the third GUI screens to produce the contents, in 830. Therefore, even a user who is not experienced in producing the contents may quickly produce contents having a high quality.

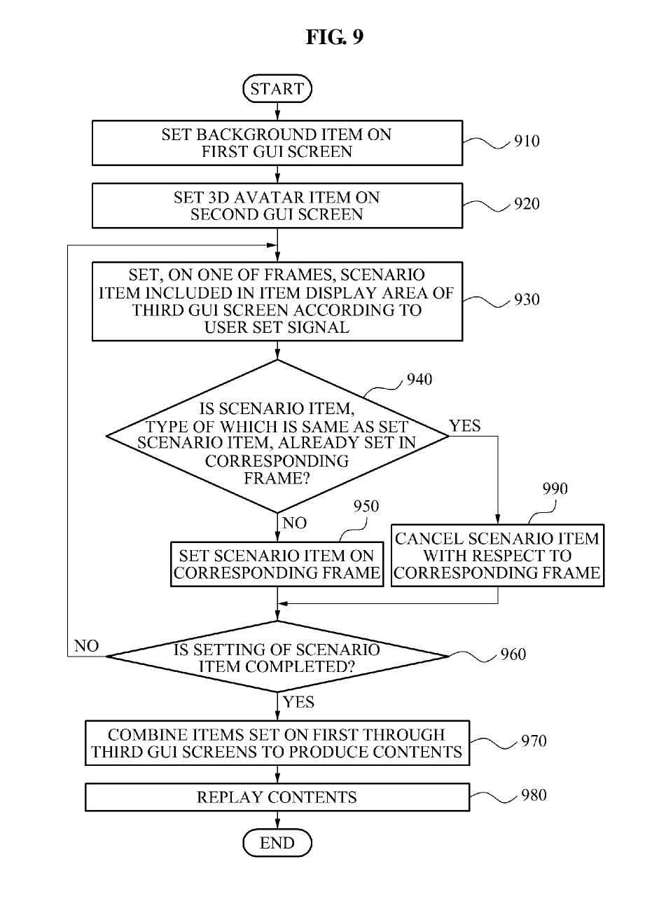

FIG. 9 illustrates another example of a method for producing contents. Referring to FIG. 9, the digital apparatus 100 may set a background item on a first GUI screen, in 910. For example, the digital apparatus 100 may set the at least one background item in response to a user set signal while the first GUI screen is displayed.

Subsequently, the digital apparatus 100 sets a 3D avatar item on a second GUI screen, in 920. For example, the digital apparatus 100 may set at least one 3D avatar item in response to a user set signal while the second GUI screen is displayed.

Subsequently, the digital apparatus 100 sets a scenario item included in an item display area of a third GUI screen, on one of the frames, based on a user set signal, in 930. For example, when one of scenario items is dragged from the item display area of the third GUI screen and is dropped on one of frames displayed in a frame display area, the digital apparatus 100 may set the dragged scenario item on the frame where the dragged scenario item is placed.

The digital apparatus 100 determines whether the scenario item to be set has the same type as the scenario item already set in the corresponding frame, in 940. When the digital apparatus 100 determines that the scenario item has a type that is the same as the scenario item that is already set in the corresponding frame, the digital apparatus cancels the setting of the dragged scenario item with respect to the corresponding frame, in 990.

Conversely, when a scenario item having the same type is not set in the corresponding frame, the digital apparatus 100 proceeds with ‘No’ of operation 940 and sets the dragged scenario item on the corresponding frame, in 950.

Subsequently, when setting at least one scenario item on each of frames is completed in 960, the digital apparatus 100 may combine items set on the first through third GUI screens to produce combined contents, in 970. The digital apparatus 100 replays the produced contents to display the contents on a screen, in 980.

Conversely, when the setting of at least one scenario item on each of frame is not completed in 960, the digital apparatus 100 may repeatedly perform operations 930 through 960.

According to the method of FIG. 9, the digital apparatus 100 may produce and replay contents having a relatively high quality using the first through the third GUI screens.

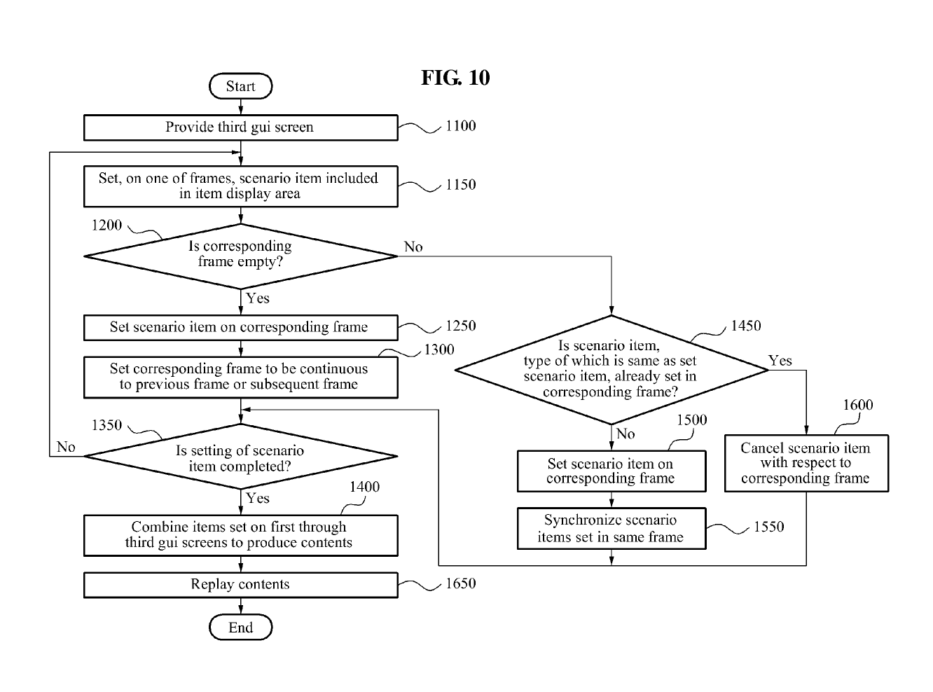

FIG. 10 illustrates another example of a method for producing contents. Referring to FIG. 10, the digital apparatus 100 provides a third GUI screen, in 1100. In this example, the digital apparatus 100 provides a first GUI screen and a second GUI screen prior to performing 1100, and an operation of setting at least one background item and at least one 3D avatar item may also be performed prior to performing operation 1100.

Subsequently, the digital apparatus 100 sets at least one scenario item included in an item display area on one of frames on the third GUI screen, in 1150. In this example, the operation of setting the at least one scenario item on the frame may be performed by sensing a motion that a scenario item is dragged and placed, by the user, on one of the frames.

The digital apparatus 100 determines whether the corresponding frame is empty, in 1200. When the corresponding frame is empty, the digital apparatus 100 sets the scenario item on the corresponding frame, in 1250. In this example, “the corresponding frame is empty” indicates that scenario items are not set on the corresponding frame.

Subsequently, the digital apparatus 100 sets the corresponding frame to be continuous to a previous frame or a subsequent frame, in 1300. Frames may be continuously replayed without discontinuity while the contents are replayed.

Subsequently, when setting of the at least one scenario item on each of the frames is completed in 1350, the digital apparatus 100 combines items set on the first through the third GUI screens to produce contents, in 1400. The digital apparatus 100 replays the produced contents to display the produced contents on a screen, in 1650.

In 1200, the digital apparatus 100 determines whether the corresponding frame is empty. If the corresponding frame is not empty, in 1450 the digital apparatus 100 determines whether a scenario to be set has a type that is the same as a scenario that is already set on the corresponding frame. When the digital apparatus 100 determines that the scenario item that has a type that is the same as the set scenario item, the digital apparatus 100 cancels the setting of the scenario item with respect to the corresponding frame, in 1600.

When a scenario item having the same type is not set in the corresponding frame, the digital apparatus 100 proceeds with ‘No’ of operation 1450, and sets the scenario item on the corresponding frame, in 1500.

Subsequently, the digital apparatus 100 synchronizes scenario items set on the same frame, in 1550. For example, the digital apparatus 100 may synchronize at least two scenario items in the same frame to have the same execution time, and may synchronize scenario items set on frames having the same frame number from among frames corresponding to different 3D avatar items to have the same execution time. In this example, the synchronization may be performed based on one of a shortest motion reference mode, a longest motion reference mode, and a random motion reference mode. The digital apparatus 100 may perform operation 1350 through operation 1650 to produce and replay the contents.

As described herein, a digital apparatus may provide a GUI for producing contents, and thus, may enable a user who is not experienced in producing the contents to quickly produce contents having a high quality. The digital apparatus may transmit produced contents to another digital apparatus to share the contents.

The above-described methods, processes, functions, and operations, may be recorded in a computer-readable storage media including program instructions to implement various operations embodied by a computer. The media may also include, alone or in combination with the program instructions, data files, data structures, and the like. Examples of computer-readable storage media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A digital apparatus, comprising:
an input unit to receive an inputted user set signal;
a graphical user interface (GUI) providing unit to provide a first GUI screen for setting at least one background item as contents, a second GUI screen for setting at least one three-dimensional (3D) avatar item as contents, and a third GUI screen for setting at least one scenario item as contents; and
a controller to control the GUI providing unit to combine the items set as contents on the first through the third GUI screens, respectively, based on the user set signal, to produce combined contents.

2. The apparatus of claim 1, wherein the GUI providing unit provides the items set as contents on the first through the third GUI screens in real time as the items are set on the first through the third GUI screens, respectively.

3. The apparatus of claim 3, wherein the at least one background item includes at least one of a stage background, a background time-zone, a background weather, a background atmosphere, and a background music.

4. The apparatus of claim 1, wherein the second GUI screen includes a sub-GUI screen for setting at least one avatar characteristic from among an accessory, clothes, a name, a facial expression, a profile, and a voice which correspond to the at least one 3D avatar item.

5. The apparatus of claim 1, wherein the third GUI screen includes an item display area where scenario items are displayed, the scenario items include at least one of a discriminating motion, a location motion, a whole body motion, a facial motion, and a conversation motion, each of which are distinguished based on body parts of the at least one 3D avatar item, and the third GUI screen includes a frame display area where a plurality of frames corresponding to the at least one 3D avatar item set on the second GUI screen are displayed.

6. The apparatus of claim 5, wherein the third GUI screen further includes a sub-menu to set a target location, with respect to the location motion, the target location corresponding to the at least one 3D avatar item and a target direction at the target location.

7. The apparatus of claim 5, wherein the frame display area displays the at least one set 3D avatar item on a first axis and arranges the plurality of frames respectively corresponding to the at least one 3D avatar item in chronological order on a second axis that is orthogonal to the first axis.

8. The apparatus of claim 5, wherein, when one of the scenario items is dragged from the item display area of the third GUI screen and is placed on one of the frames displayed on the frame display area, the GUI providing unit sets the dragged scenario item on the frame where the dragged scenario is placed.

9. The apparatus of claim 8, wherein, when the placed scenario item is of the same type of as a scenario item that is already set on the frame where the dragged scenario is placed, the GUI providing unit cancels the setting of the dragged scenario item.

10. The apparatus of claim 8, wherein, when the at least one scenario item is set on each of the plurality of frames, the GUI providing unit synchronizes the at least one scenario item set on the same frame based on one of a shortest motion reference mode, a longest motion reference mode, and a random motion reference mode.

11. The apparatus of claim 1, further comprising:
a communication unit to communicate with other digital apparatuses,
wherein the controller controls the communication unit to transmit the contents produced by the GUI providing unit to a predetermined another digital apparatus.

12. A method of providing a GUI for producing contents, the method comprising:
providing a first GUI screen for setting at least one background item as contents;
providing a second GUI screen for setting at least one 3D avatar item as contents;
providing a third GUI screen for setting at least one scenario item as contents; and
producing combined contents by combining the items set as contents on the first through the third GUI screens, respectively, based on a user set signal.

13. The method of claim 12, wherein the producing comprises:
providing the items set as contents on the first through the third GUI screens in real time as the items are set on the first through the third GUI screens, respectively.

14. The method of claim 12, wherein the second GUI screen includes a sub-GUI screen for setting at least one avatar characteristic from among an accessory, clothes, a name, a facial expression, a profile, and a voice which correspond to the at least one 3D avatar item.

15. The method of claim 12, wherein the third GUI screen includes an item display area where scenario items are displayed, the scenario items include at least one of a discriminating motion, a location motion, a whole body motion, a facial motion, and a conversation motion, each of which are distinguished based on body parts of the at least one 3D avatar item, and the third GUI screen includes a frame display area where a plurality of frames corresponding to the at least one 3D avatar item set on the second GUI screen are displayed.

16. The method of claim 15, wherein the frame display area displays the at least one set 3D avatar item on a first axis and arranges the plurality of frames respectively corresponding to the at least one 3D avatar item in chronological order on a second axis that is orthogonal to the first axis.

17. The method of claim 15, wherein the producing comprises:
setting a dragged scenario item on a frame where the dragged scenario is placed, when one of the scenario items is dragged from the item display area of the third GUI screen and is placed on one of the frames displayed on the frame display area.

18. The method of claim 17, wherein the producing comprises:
cancelling the setting of the dragged scenario item when the placed scenario item is of the same type as a scenario item that is already set on the frame.

19. The method of claim 17, wherein the producing comprises:
synchronizing the at least one scenario item set on the same frame based on one of a shortest motion reference mode, a longest motion reference mode, and a random motion reference mode, when the at least one scenario item is set on each of the plurality of frames.

20. A computer-readable storage medium having stored therein program instructions to cause a processor to implement a method of providing a GUI for producing contents, the method comprising:
providing a first GUI screen for setting at least one background item as contents;
providing a second GUI screen for setting at least one 3D avatar item as contents;
providing a third GUI screen for setting at least one scenario item as contents; and
producing combined contents by combining the items set as contents on the first through the third GUI screens, respectively, based on a user set signal.
